(19) United States
(12) Patent Application Publication
(10) Pub. No.: US 2009/0072096 A1
(43) Pub. Date: Mar. 19, 2009

(54) Control System for Train Marshalling in Gravity Hump Yards

(76) Inventor: Manfred Ottow, Berlin (DE)

Correspondence Address: COLLARD & ROE, P.C., 1077 NORTHERN BOULEVARD, ROSLYN, NY, 11576, US

(21) Appl. No.: 11/886,503

(22) PCT Filed: Mar. 3, 2006
(86) PCT No.: PCT/EP2006/001936

§ 371 Date: Sep. 17, 2007

(30) Foreign Application Priority Data
Mar. 17, 2005 (DE) 102005012814.9

(51) Int. Cl. B61L 17/00; G06F 17/00

(52) U.S. Cl. 246/182 BH; 701/20

(57) ABSTRACT

The invention relates to a method for controlling train formation in marshalling yards.

The control method according to the invention optimises the performance of a marshalling yard by a learning effect based on feed-back. The intervals of time between gravity humps are selected very long on commencement of use of the control system, and data are collected by the gravity humps. A computer determines from the time intervals that occur in these gravity humps in the critical zones of the marshalling yard whether the time interval between push-offs on the hump in the yard may or may not be reduced.

The advantage of such a self-learning system is that it requires a much smaller number of programs than conventional systems, which are based on rigid algorithms and the measurement of many factors, and which still remain rigid despite all efforts to record all the influences.

The maintenance cost is also considerably reduced. Because of the special capacity of the software the cost of adaptation from station to station is much lower than previously.

The invention relates to a method for controlling train marshalling in gravity hump yards.

In train marshalling systems for goods trains arriving trains consisting of wagons with different places of destination are uncoupled from one another. The trains are divided into individual wagons or sets of wagons, which are then set back over a dual hump and sorted by a system of points into so-called marshalling tracks. The wagons are given sufficient speed by the dual hump to pass through the sorting process and cover the required distance on the marshalling track. To maximise the throughput the wagons, so-called humps, should on the one hand pass through the system as quickly as possible, and on the other they must not exceed a speed of 1.5 m/s on aggregation with wagons already on the corresponding marshalling track. As far as control is concerned the most serious problem lies in ensuring that wagons with different running characteristics when minimising the time between two humps, and also ensuring that the interval of time between such wagons that must be separated by switching points is sufficient to be able to carry out the separation without risk. A critical situation arises particularly when a wagon with good running characteristics, a so-called good runner, follows a wagon with poor running characteristics, a so-called poor runner.

In the control method of prior art the physical processes of the humps are designed with the maximum possible mathematical accuracy. The physical quantities contained in the mathematical model, in the form of constants or variables, are measured either once only or continuously by sensors. The measured values are integrated in the functions and the instantaneous values of the position and speed of all the wagons in the gravity hump are calculated. The control variables for the points and brakes are calculated from these data so that a safe procedure with maximised throughput is achieved. Since a number of factors have to be measured on the large area of the marshalling yards, a very large number of sensors is required, e.g. geometric quantities of the wagons are recorded with light barriers, the mass of the wagons with weigh bridges, the speeds with Doppler radar measuring devices, and also at critical points with track contacts. In addition, very many topographical characteristics, such as heights, gradients and curves, are included in the calculations.

Weather data are also incorporated in the calculations. What is of particular importance for safety in the yards is the constantly unambiguous balancing of the incoming and outgoing trains. If counting devices such as track contacts occasionally measure inaccurately, the balance is disturbed. Test devices are therefore provided at critical points so that the filling level data can be reliably indicated. Although the costs of such yards have increased considerably due to the expense incurred, which has grown considerably during the development time, they nevertheless reliably produce satisfactory results.

Disadvantages of the control methods of prior art include in particular, however:
the fact that extraordinarily complicated, expensive control software has to be used because a huge quantity of measured values is collected and must be processed; this software must also be adapted to a considerable degree to each marshalling yard so that individual solutions are almost always produced; this also results in correspondingly high update costs,
the fact that high hardware expenditure must be incurred; moreover, modifications to obsolete hardware incur very high costs every six years or so; since spare parts are often no longer available, modernisation must be carried out even then, even though it may not yet be technically required,
because the SPS control systems previously used have the required real time capacity for signal processing and control processes, and are also crashproof, the control systems were previously always constructed in a plurality of planes; however, this structure results in very expensive hardware,
a measurement cost that increases at least proportionately to the size of the gravity hump yard, resulting in approximately 2000 sensors in large yards.

In addition to the high investment costs of the control technology involved in establishing new years, the frequent modernisations of these control systems result in high life cycle costs compared to machine technology.

The object of this invention is therefore to provide a method for controlling train formation in gravity hump yards, which method incurs an investment cost of the software and computer hardware, and of sensors, cabling and installation, that is considerably lower than the prior art.

This object is achieved according to the invention by the features indicated in Claim 1 in conjunction with the preamble of Claim 1.

Claims 2 to 10 describe advantageous exemplary embodiments of the solution according to the invention in Claim 1.

The control process according to the invention according to Claim 1 optimises the performance of a marshalling yard because of a learning effect based on feed-back. The intervals of time between gravity humps are chosen very long, particularly when commencing use of the control system, and data are collected by the gravity humps.

These data include, in particular,
Fixed vehicle characteristics such as the number of axles (allocation relating to 2-, 4- or 6-axle wagons), height of the superstructures of the wagons and known peculiarities if the wagon repeatedly runs through the marshalling yard,
Variable vehicle characteristics, in particular the weight of the wagons with the weight of the wagons being recorded on the marshalling measurement section (AM) and a formation of weight classes,
Section characteristics such as speed level of the gravity humps before the retarder (running characteristic) and common point passages for consecutive gravity humps.

A computer determines from the intervals of time that occur with these gravity humps in the critical zones of the years whether the time interval between push-offs on the yard hump may or may not be reduced.

Here the critical zones are the zones between the retarder or retarders and the last points before the respective marshalling track brakes. The critical value is the distance between two humps (wagons) before the point on which the branches of the gravity humps separate. This distance must be sufficient to be able to reverse the points safely. This critical value is in this case determined in particular by track contacts and point inlet contacts.

The control values required for the retarders in particular can be determined for the required outlet speeds. Here the retarder is controlled by means of a speed measurement, in particular with radar measuring devices and rail contacts. The permissible speeds are, in this case:
4 m/s to 5 m/s for the outlet speed from the gravity hump, according to the track length as far as the marshalling track brake,
4.5 m/s for the inlet speed in the marshalling track brake, and
1.5 m/s for the outlet speed from the marshalling track brake.

The advantage of such a self-learning system is that requires far fewer programs than conventional systems which are based on rigid algorithms and the measurement of many factors and which, despite all efforts to record all influences, remain rigid.

The maintenance cost is also considerably reduced. Because of the special capacity of the software the cost of adaptation from one station to another is much lower than before.

The method according to the invention advantageously forms a limited number of classes of events. In particular, classes are formed as values characteristic of the travel resistance according to Claim 8 according to vehicle mass and the size of the air resistance, in this case the vertical projection surface in particular. The system itself is continuously optimised taking into consideration these classes. As soon as it is detected that the interval of time is reduced over several gravity humps in succession, the system reacts by again extending the distances through the brakes or by extending the distances between the set-off processes.

The basic method is universally applicable, so that fewer adaptations are advantageously required to be able to apply the method to different marshalling yards.

Together with simplifying the control system, data bus systems are used according to Claim 9 for guiding the sensor signals and signals to the control elements. Since the signal transmission itself is managed by bus systems in safety-relevant systems such as those in the aviation industry, these advantages are now also being introduced in the far less safety-relevant marshalling installations. This ensures that a saving of hundreds of cable kilometres is achieved in a particularly advantage manner.

According to Claim 10 the memory-programmable control systems previously used for real-time processing are replaced by real-time PC configurations. The entire control system of a marshalling yard is therefore incorporated in a central computer assisted in particular by a redundant system.

A rough estimate shows that costs of a new yard can be reduced by approx. 60% with the system described.

The invention is explained in greater detail below with reference to an advantageous exemplary embodiment and a drawing with a FIGURE. The FIGURE shows diagrammatically marshalling yard with three marshalling tracks.

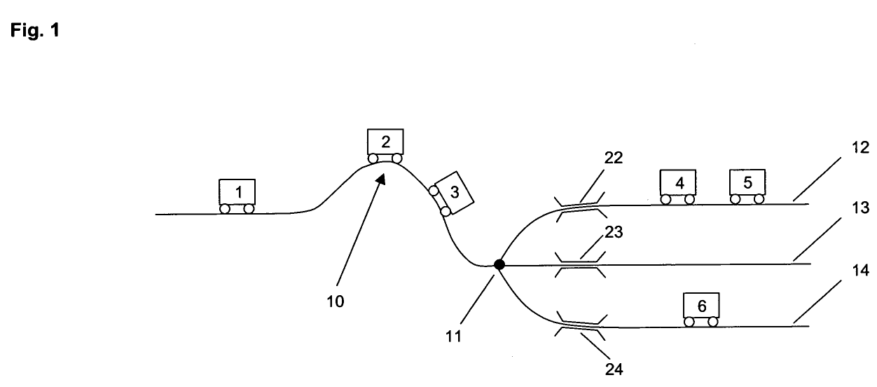

The marshalling yard according to FIG. 1 consists of a gravity hump 10 over which wagons are pushed and from there run into marshalling tracks 12, 13 or 14 independently due to the force of gravity and are there braked by retarders 22, 23 and 24. Each wagon is assigned to the associated marshalling tack by a point 11.

Here the individual wagons have running resistances that vary according to the maintenance condition of the wheel bearings, wagon type or loading, i.e. the wagons roll down the gravity hump and into the marshalling tracks at different speeds.

When the control system commences operation the intervals of time between the individual wagons are chosen very long and data are collected by the gravity humps. Here a sensor determines the intervals of time between the individual wagons passing through in the extremely critical zone of point 11. If it transpires that the time between the wagons running off is greater than the time for reversing point 11, the distance between the wagons which are pushed over gravity hump 10 can be reduced by a certain amount. If it is then transpires that the time between the wagons running off is still longer than the time for reversing point 11, the distance between the wagons pushed over gravity hump 10 can be reduced by a further certain amount. This method is continued until the time between the wagons running off is slightly longer than the time required for reversing point 11.

Similarly the control values required for retarders 22, 23 and 24 can be determined for the outlet speeds for running into marshalling tracks 12, 13 and 14. If it transpires that the speed of wagon 4 braked by retarder 22 is too low, to approach the wagons 5 already on the marshalling track 12, the braking force of retarder 22 is reduced. If it then transpires that the speed of a wagon braked by retarder 22 is still too low to approach the wagons already on marshalling track 12, the braking force of retarder 22 is further reduced. This method is continued until the speed of the wagons braked by retarder 22 is selected so that they run into wagons already on the marshalling track at no more than the maximum permissible speed of 1.5 m/s.

### LIST OF REFERENCE NUMBERS

1 Wagon 1
2 Wagon 2
3 Wagon 3
4 Wagon 4
5 Wagon 5
6 Wagon 6
Gravity hump
11 Pont
12 Marshalling track 1
13 Marshalling track 2
14 Marshalling track 3
22 Retarder 1
23 Retarder 2
24 Retarder 3

1. A method for controlling train formation in marshalling yards in which arriving trains which consist of wagons with different destinations, divided into individual wagons or wagon sets, pushed over a gravity hump and sorted by a system of points into so-called marshalling tracks and are braked by retarders and marshalling track brakes, wherein the time intervals between gravity humps are initially selected long and data are collected by the gravity humps, and in that it is determined from the intervals of time which occur in these gravity humps in critical zones of the yard whether the interval of time between the push-offs on the hump of the yard has to be reduced or extended or remains the same.

2. The method for controlling train formation in marshalling yards according to claim 1, wherein the data which are collected by the gravity humps are fixed and/or variable vehicle characteristics and/or section characteristics.

3. The method for controlling train formation in marshalling yards according to claim 1, wherein the critical zones are the zones between the retarders or between the retarders and the last points before the respective marshalling track brakes.

4. The method for controlling train formation in marshalling yards according to claim 1, wherein the method is employed on commencement of using the control system.

5. The method for controlling train formation in marshalling yards according to claim 1, wherein control values required for retarders are determined for the desired outlet speeds.

6. The method for controlling train formation in marshalling yards according to claim 5, wherein the retarder is controlled by speed measurement with radar measuring devices and rail contacts.

7. The method for controlling train formation in marshalling yards according to claim 5, wherein the outlet speed from the gravity hump is 4 m/s to 5 m/s, the inlet speed into the retarder is 4.5 m/s, and the outlet speed from the retarder is 1.5 m/s.

8. The method for controlling train formation in marshalling yards according to claim 1, wherein the wagons arriving in the marshalling yard are divided into classes based on vehicle mass and air resistance.

9. The method for controlling train formation in marshalling yards according to claim 1, wherein the sensor signals and the signals to the control elements are guided by data bus systems.

10. The method for controlling train formation in marshalling yards according to claim 1, wherein real time PC configurations are used for real time processing.
